(19) United States
(12) Patent Application Publication
(10) Pub. No.: US 2024/0163142 A1
(43) Pub. Date: May 16, 2024

(54) GAP-ASSISTED PHASE COHERENT TRANSMISSIONS

(71) Applicant: QUALCOMM Incorporated, San Diego, CA (US)

(72) Inventors: Marwen ZORGUI, San Diego, CA (US); Xiaoxia ZHANG, San Diego, CA (US); Srinivas YERRAMALLI, San Diego, CA (US)

(21) Appl. No.: 17/988,179

(22) Filed: Nov. 16, 2022

(51) Int. Cl. H04L 27/00; H04L 5/00

(52) U.S. Cl. CPC H04L 27/0006; H04L 5/0053; H04L 5/0073

(57) ABSTRACT

Techniques are provided for generating and utilizing transmission gaps (TGs) to assist with phase discontinuity issues in positioning and sensing operations. An example method for transmitting coherent reference signals with a wireless node includes determining transmission gap configuration information for transmitting coherent reference signals, determining overlapping signals based on a duration of time defined by the transmission gap configuration information, and transmitting one or more coherent reference signals and dropping one or more of the overlapping signals during the duration of time defined by the transmission gap configuration information.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communication (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

5G enables the utilization of radio frequency (RF) signals for wireless communication between network nodes, such as base stations, user equipment (UEs), vehicles, factory automation machinery, and the like. The RF signals can be used for other purposes as well. For example, RF signals can be used for RF sensing applications for detecting and tracking objects with RF signals. The RF sensing signals, and corresponding transmitter and receiver configurations, may be utilized to determine the velocity and motion of the objects.

### SUMMARY

An example method for transmitting coherent reference signals with a wireless node according to the disclosure includes determining transmission gap configuration information for transmitting coherent reference signals, determining overlapping signals based on a duration of time defined by the transmission gap configuration information, and transmitting one or more coherent reference signals and dropping one or more of the overlapping signals during the duration of time defined by the transmission gap configuration information.

An example method for activating a transmission gap for transmitting coherent reference signals with a wireless node according to the disclosure includes receiving transmission gap configuration information for transmitting coherent reference signals, activating the transmission gap based at least in part on the transmission gap configuration information, and transmitting one or more coherent reference signals during a duration of time defined by the transmission gap configuration information.

Items and/or techniques described herein may provide one or more of the following capabilities, as well as other capabilities not mentioned. A wireless node may be capable of transmitting and/or receiving radio frequency (RF) sensing signals. The wireless node may utilize the same receivers for both communications and RF sensing operations. The wireless node may be configured to transmit phase coherent reference signals to enhance radio frequency sensing operations. Transmission gaps (TGs) may be utilized to reduce issues associated with phase discontinuity. Coherent reference signals may be transmitted during a transmission gap. The wireless node may be configured to drop the transmission or reception of other reference signals during a TG. A network entity may provide TG configuration information to wireless nodes such as transmission reception points and user equipment. A pre-configured TG may be activated with low level signaling. Object detection and classification may be improved based on the use of phase coherent reference signals during a TG. Other capabilities may be provided and not every implementation according to the disclosure must provide any, let alone all, of the capabilities discussed.

### BRIEF DESCRIPTION OF THE DRAWINGS

The accompanying drawings are presented to aid in the description of examples of the disclosed subject matter and are provided solely for illustration of the examples and not limitations thereof:

FIG. 1 illustrates an example wireless communications system.

FIGS. 2A and 2B illustrate example wireless network structures.

FIGS. 3A to 3C are simplified block diagrams of several sample components that may be employed in wireless communication nodes and configured to support communication.

FIG. 4A illustrates an example monostatic radar system.

FIG. 4B illustrates an example bistatic radar system.

FIG. 5 is an example graph showing a radio frequency (RF) channel response over time.

FIGS. 6A and 6B illustrate signal transmissions that are phase-coherent and that are not phase-coherent, respectively.

FIG. 6C illustrates a MIMO antenna array and its virtual equivalent.

FIGS. 7A-7C are diagrams of example use cases for reference signal transmissions with gap-assisted coherent transmissions.

FIG. 8 is a diagram of example gap-assisted coherent transmissions with multiple component carriers.

FIG. 9 is an example message flow diagram for providing transmission gap configuration information.

FIG. 10 is an example process flow diagram of a method for transmitting coherent reference signals with a wireless node.

FIG. 11 is an example process flow diagram of a method for activating a transmission gap for transmitting coherent reference signals with a wireless node.

### DETAILED DESCRIPTION

Techniques are provided herein for generating and utilizing transmission gaps (TGs) to assist with phase discontinuity issues in positioning and sensing operations. A set of rules may be implemented to determine the behavior of a network node within the duration of a TG. For example, during a TG only configured phase-coherent reference signals (i.e., coherent RSs) may be transmitted such that even if other transmissions have higher priority than the coherent RSs, the other RS transmissions may be dropped. In an example, during a TG, the coherent RSs may be transmitted and other RS transmissions with higher priorities than the coherent RS may be inserted into the TG where possible. A network node configured with multiple carriers may be configured to drop transmissions on a first carrier during a TG which overlap in time with coherent RS transmissions on a second carrier. A network node may be configured to schedule multiple sets of coherent transmissions on different beams during a TG. A TG may be configured per network node or per frequency range (FR). These techniques are examples, and not exhaustive.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “wireless node,” “user equipment” (UE) and “base station” (BS) are not intended to be specific or otherwise limited to any particular radio access technology (RAT), unless otherwise noted. User equipment and base stations are examples of wireless nodes. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

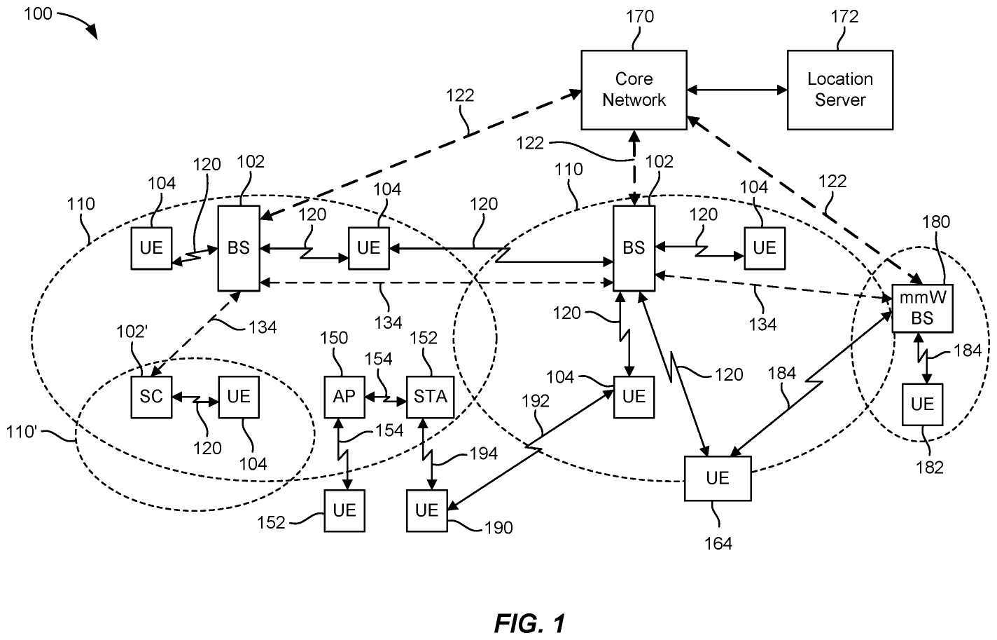

Referring to FIG. 1, an example wireless communications system 100 is shown. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STA 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a base station. The UE can then form a transmit beam for sending one or more uplink reference signals (e.g., uplink positioning reference signals (UL-PRS), sounding reference signal (SRS), demodulation reference signals (DMRS), PTRS, etc.) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over communication links 120 and/or the mmW base station 180 over a mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

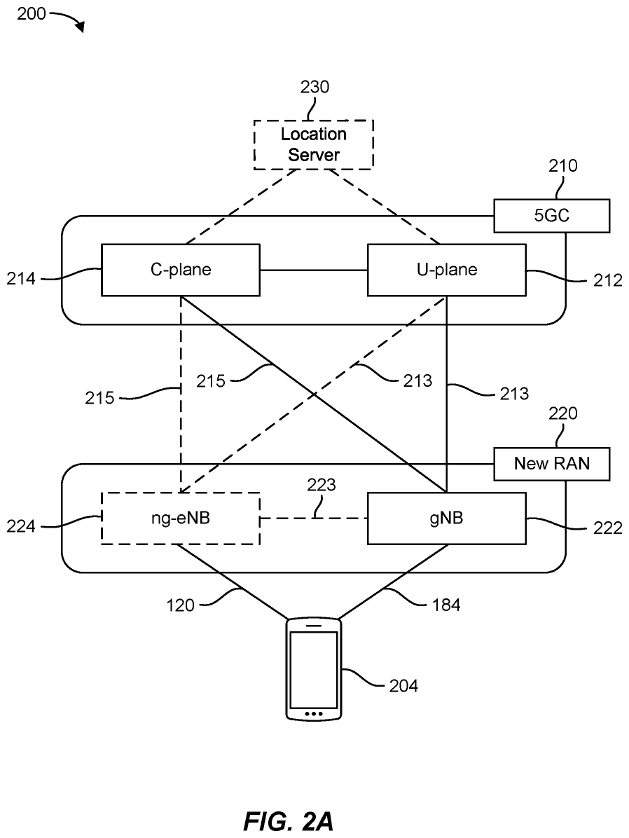

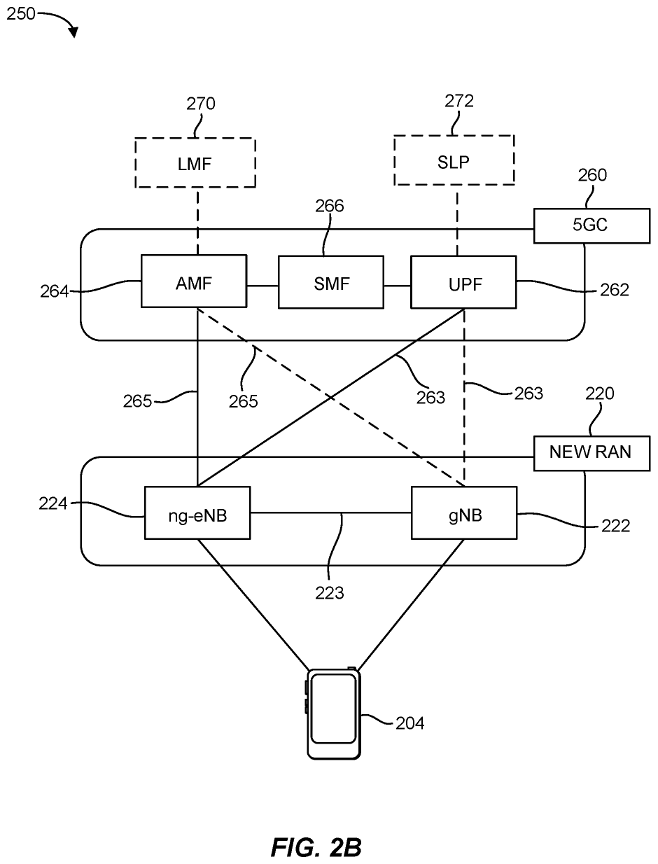

Referring to FIG. 2A, an example wireless network structure 200 is shown. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network.

Referring to FIG. 2B, another example wireless network structure 250 is shown. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

In an aspect, the LMF 270 and/or the SLP 272 may be integrated into a base station, such as the gNB 222 and/or the ng-eNB 224. When integrated into the gNB 222 and/or the ng-eNB 224, the LMF 270 and/or the SLP 272 may be referred to as a “location management component,” or “LMC.” However, as used herein, references to the LMF 270 and the SLP 272 include both the case in which the LMF 270 and the SLP 272 are components of the core network (e.g., 5GC 260) and the case in which the LMF 270 and the SLP 272 are components of a base station.

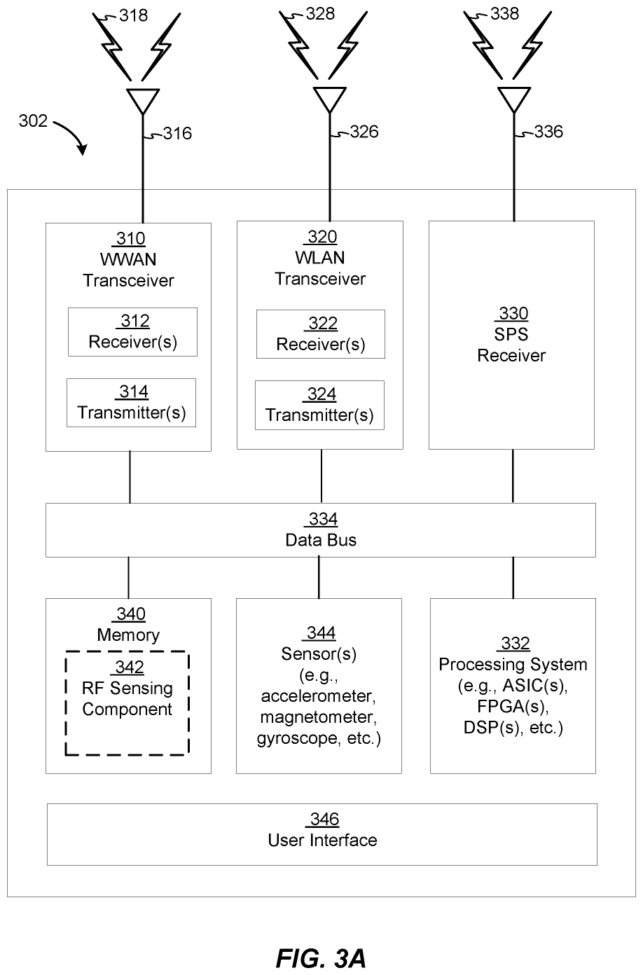

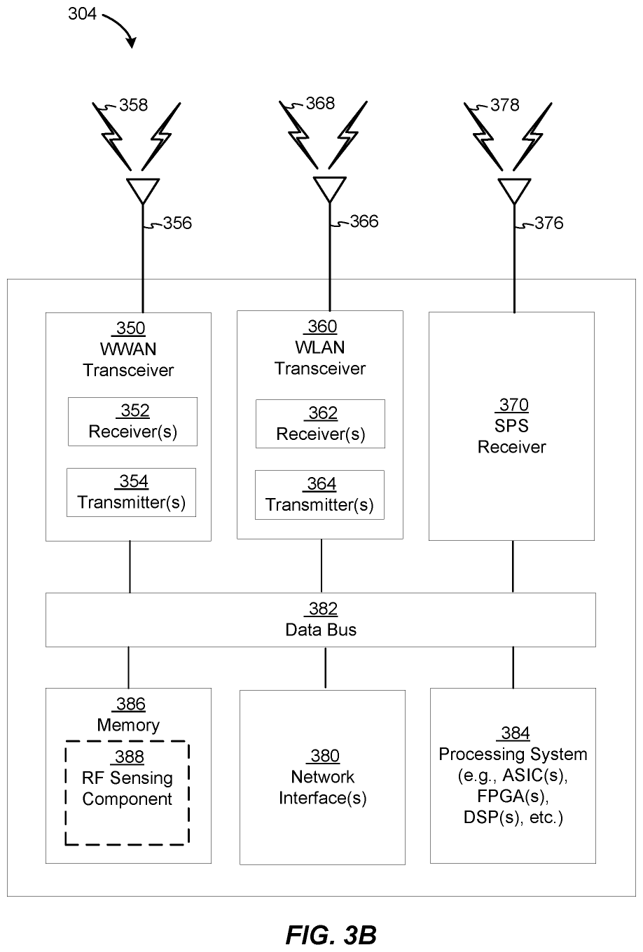

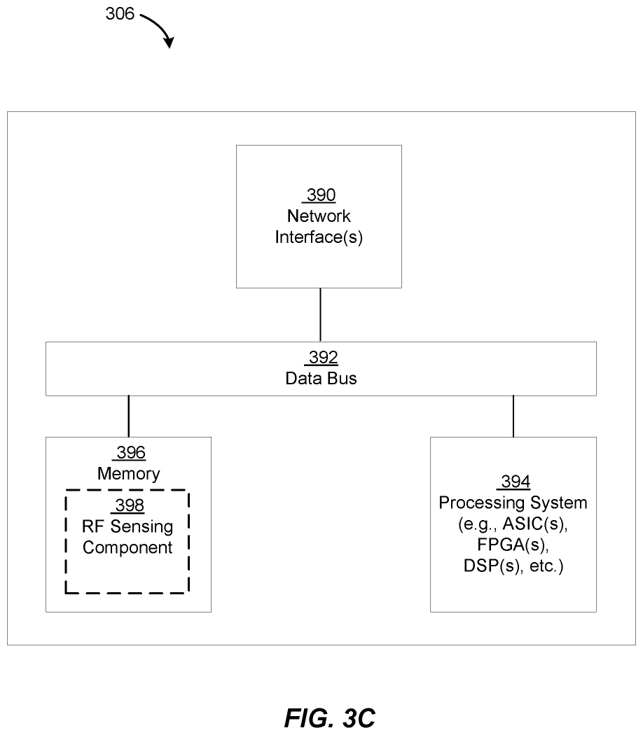

Referring to FIGS. 3A, 3B and 3C, several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations are shown. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, configured to communicate via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, wireless local area network (WLAN) transceivers 320 and 360, respectively. The WLAN transceivers 320 and 360 may be connected to one or more antennas 326 and 366, respectively, for communicating with other network nodes, such as other UEs, access points, base stations, etc., via at least one designated RAT (e.g., WiFi, LTE-D, Bluetooth®, etc.) over a wireless communication medium of interest. The WLAN transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, for receiving SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine positions of the UE 302 and the base station 304 using measurements obtained by any suitable SPS algorithm.

The base station 304 and the network entity 306 each include at least one network interfaces 380 and 390 for communicating with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

The UE 302, the base station 304, and the network entity 306 also include other components that may be used in conjunction with the operations as disclosed herein. The UE 302 includes processor circuitry implementing a processing system 332 for providing functionality relating to, for example, RF sensing, and for providing other processing functionality. The base station 304 includes a processing system 384 for providing functionality relating to, for example, RF sensing as disclosed herein, and for providing other processing functionality. The network entity 306 includes a processing system 394 for providing functionality relating to, for example, RF sensing as disclosed herein, and for providing other processing functionality. In an aspect, the processing systems 332, 384, and 394 may include, for example, one or more general purpose processors, multi-core processors, ASICs, digital signal processors (DSPs), field programmable gate arrays (FPGA), or other programmable logic devices or processing circuitry.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). In some cases, the UE 302, the base station 304, and the network entity 306 may include RF sensing components 342, 388, and 398, respectively. The RF sensing components 342, 388, and 398 may be hardware circuits that are part of or coupled to the processing systems 332, 384, and 394, respectively, that, when executed, cause the UE 302, the base station 304, and the network entity 306 to perform the functionality described herein. In other aspects, the RF sensing components 342, 388, and 398 may be external to the processing systems 332, 384, and 394 (e.g., part of a modem processing system, integrated with another processing system, etc.). Alternatively, the RF sensing components 342, 388, and 398 may be memory modules (as shown in FIGS. 3A-C) stored in the memory components 340, 386, and 396, respectively, that, when executed by the processing systems 332, 384, and 394 (or a modem processing system, another processing system, etc.), cause the UE 302, the base station 304, and the network entity 306 to perform the functionality described herein.

The UE 302 may include one or more sensors 344 coupled to the processing system 332 to provide movement and/or orientation information that is independent of motion data derived from signals received by the WWAN transceiver 310, the WLAN transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 and Layer-2 functionality.

In the uplink, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the downlink transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the uplink, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the UE 302, the base station 304, and/or the network entity 306 are shown in FIGS. 3A-C as including various components that may be configured according to the various examples described herein. It will be appreciated, however, that the illustrated blocks may have different functionality in different designs.

The various components of the UE 302, the base station 304, and the network entity 306 may communicate with each other over data buses 334, 382, and 392, respectively. The components of FIGS. 3A-C may be implemented in various ways. In some implementations, the components of FIGS. 3A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by components 310 to 346 may be implemented by processor and memory component(s) of the UE 302 (e.g., by execution of appropriate code and/or by appropriate configuration of processor components). Similarly, some or all of the functionality represented by components 350 to 388 may be implemented by processor and memory component(s) of the base station 304 (e.g., by execution of appropriate code and/or by appropriate configuration of processor components). Also, some or all of the functionality represented by components 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 332, 384, 394, the transceivers 310, 320, 350, and 360, the memory components 340, 386, and 396, the RF sensing components 342, 388, and 398, etc.

Wireless communication signals (e.g., RF signals configured to carry OFDM symbols) transmitted between a UE and a base station can be reused for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, etc. As a particular example, the wireless communication signals may be an OFDM waveform as utilized in LTE and NR. High-frequency communication signals, such as mmW RF signals, are especially beneficial to use as radar signals because the higher frequency provides, at least, more accurate range (distance) detection.

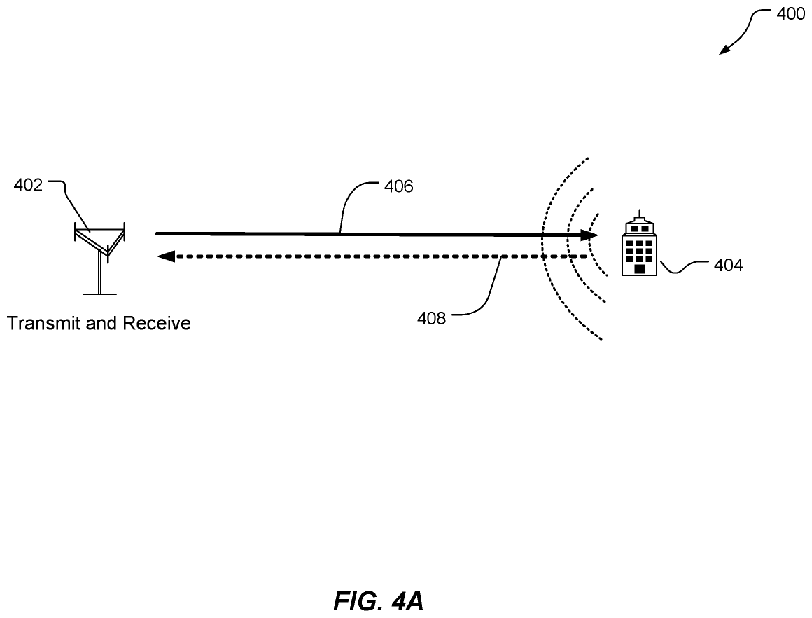

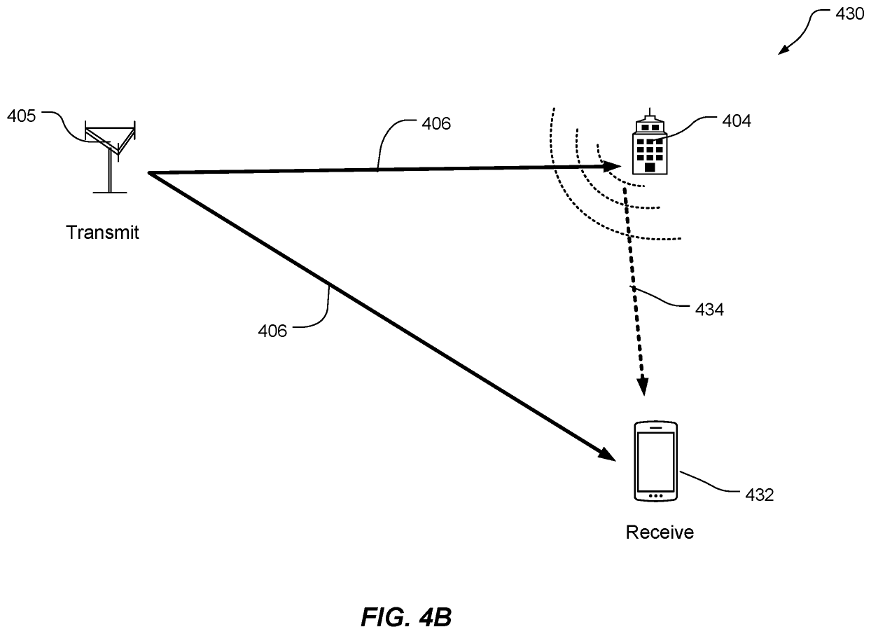

In general, there are different types of radar, and in particular, monostatic and bistatic radars. FIGS. 4A and 4B illustrate two of these various types of radar. Specifically, FIG. 4A is a diagram 400 illustrating a monostatic radar scenario, and FIG. 4B is a diagram 430 illustrating a bistatic radar scenario. In FIG. 4A, a base station 402 may be configured for full duplex operation and thus the transmitter (Tx) and receiver (Rx) are co-located. For example, a transmitted radio frequency (RF) signal 406 may be reflected off of a target object, such as a building 404, and the receiver on the base station 402 is configured to receive and measure a reflected beam 408. This is a typical use case for traditional, or conventional, radar. In an example, monostatic radio sensing may be realized with half duplex operation such that a transceiver may be configured to transmit a RF sensing signal at a first time, and then receive a reflected signal at a second time. In FIG. 4B, a base station 405 may be configured as a transmitter (Tx) and a UE 432 may be configured as a receiver (Rx). In this example, the transmitter and the receiver are not co-located, that is, they are separated. The base station 405 may be configured to transmit a beam, such as an omnidirectional downlink RF signal which may be received by the UE 432. A portion of the RF signal 406 may be reflected or refracted by the building 404 and the UE 432 may receive this reflected signal 434. This is the typical use case for wireless communication-based (e.g., WiFi-based, LTE-based, NR-based) RF sensing. Note that while FIG. 4B illustrates using a downlink RF signal 406 as a RF sensing signal, uplink RF signals can also be used as RF sensing signals. In a downlink scenario, as shown, the transmitter is the base station 405 and the receiver is the UE 432, whereas in an uplink scenario, the transmitter is a UE and the receiver is a base station.

Referring to FIG. 4B in greater detail, the base station 405 transmits RF sensing signals (e.g., PRS) to the UE 432, but some of the RF sensing signals reflect off a target object such as the building 404. The UE 432 can measure the ToAs of the RF signal 406 received directly from the base station, and the ToAs of the reflected signal 434 which is reflected from the target object (e.g., the building 404).

The base station 405 may be configured to transmit the single RF signal 406 or multiple RF signals to a receiver (e.g., the UE 432). However, the UE 432 may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 4B, the RF signal 406 follows a LOS path between the base station 405 and the UE 432, and the reflected signal 434 represents the RF sensing signals that followed a NLOS path between the base station 405 and the UE 432 due to reflecting off the building 404 (or another target object). The base station 405 may have transmitted multiple RF sensing signals (not shown in FIG. 4B), some of which followed the LOS path and others of which followed the NLOS path. Alternatively, the base station 405 may have transmitted a single RF sensing signal in a broad enough beam that a portion of the RF sensing signal followed the LOS path and a portion of the RF sensing signal followed the NLOS path.

Based on the difference between the ToA of the LOS path, the ToA of the NLOS path, and the speed of light, the UE 432 can determine the distance to the building 404. In addition, if the UE 432 is capable of receive-beam forming, the UE 432 may be able to determine the general direction to the building 404 as the direction of the reflected signal 434, which is the RF sensing signal following the NLOS path as received. The UE 432 may then optionally report this information to the transmitting base station 405, an application server associated with the core network, an external client, a third-party application, or some other entity. Alternatively, the UE 432 may report the ToA measurements to the base station 405, or other entity, and the base station 405 may determine the distance and, optionally, the direction to the target object.

Note that if the RF sensing signals are uplink RF signals transmitted by the UE 432 to the base station 405, the base station 405 would perform object detection based on the uplink RF signals just like the UE 432 does based on the downlink RF signals.

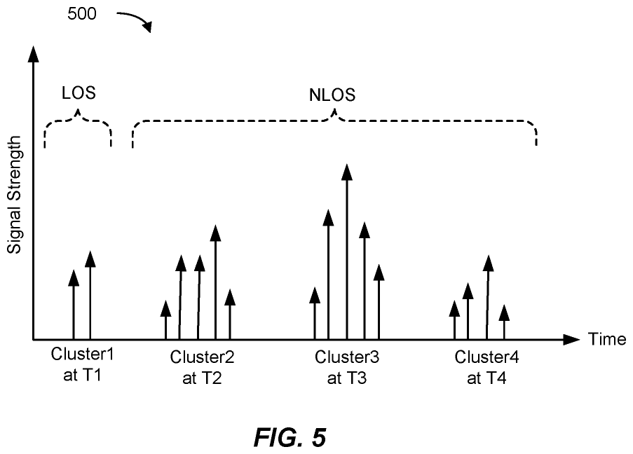

Referring to FIG. 5, an example graph 500 showing an RF channel response at a receiver (e.g., any of the UEs or base stations described herein) over time is shown. In the example of FIG. 5, the receiver receives multiple (four) clusters of channel taps. Each channel tap represents a multipath that an RF signal followed between the transmitter (e.g., any of the UEs or base stations described herein) and the receiver. That is, a channel tap represents the arrival of an RF signal on a multipath. Each cluster of channel taps indicates that the corresponding multipaths followed essentially the same path. There may be different clusters due to the RF signal being transmitted on different transmit beams (and therefore at different angles), or because of the propagation characteristics of RF signals (potentially following widely different paths due to reflections), or both.

Under the channel illustrated in FIG. 5, the receiver receives a first cluster of two RF signals on channel taps at time T1, a second cluster of five RF signals on channel taps at time T2, a third cluster of five RF signals on channel taps at time T3, and a fourth cluster of four RF signals on channel taps at time T4. In the example of FIG. 5, because the first cluster of RF signals at time T1 arrives first, it is presumed to be the LOS data stream (i.e., the data stream arriving over the LOS or the shortest path), and may correspond to the LOS path illustrated in FIG. 4B (e.g., the RF signal 406). The third cluster at time T3 is comprised of the strongest RF signals, and may correspond to the NLOS path illustrated in FIG. 4B (e.g., the reflected signal 434). Note that although FIG. 5 illustrates clusters of two to five channel taps, as will be appreciated, the clusters may have more or fewer than the illustrated number of channel taps.

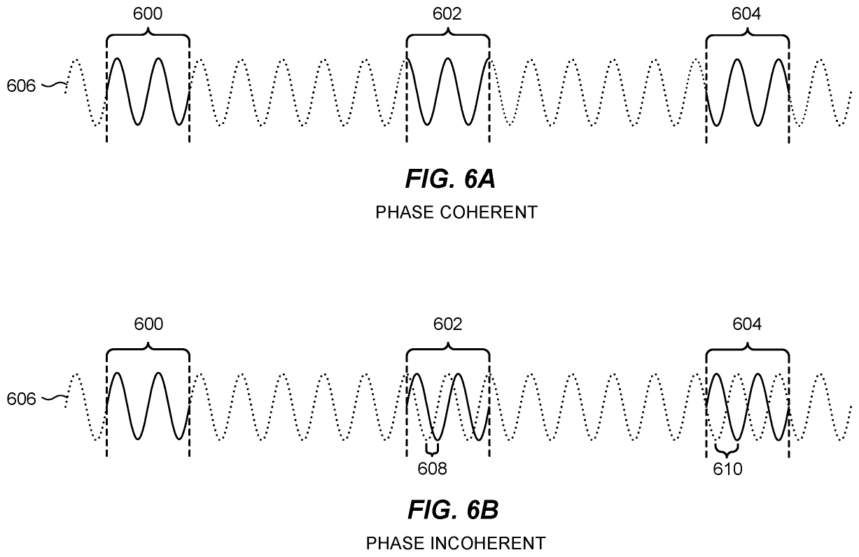

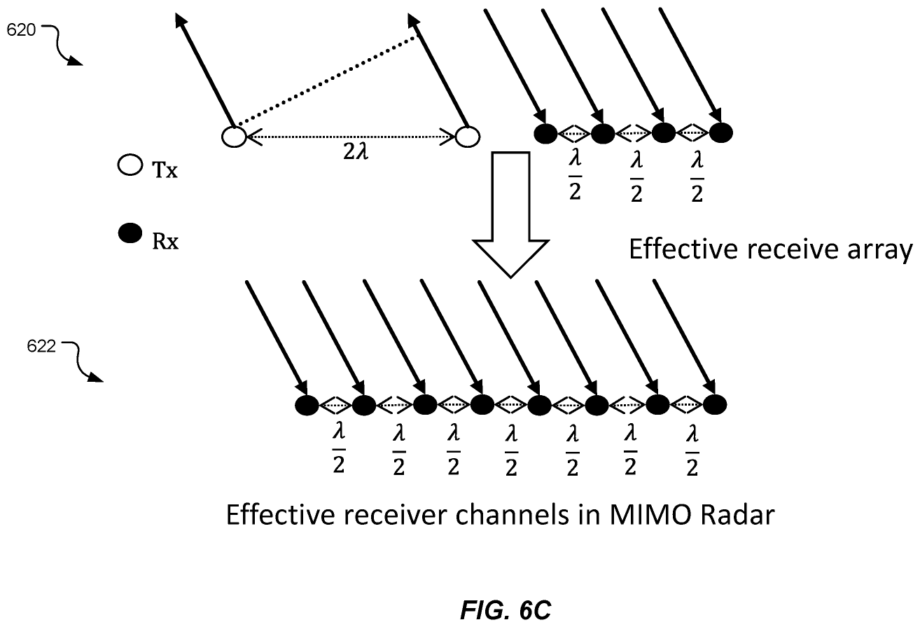

Referring to FIG. 6A, three transmissions of a signal which have phase coherence relative to each other are shown. In the simplified signal over time plot shown in FIG. 6A, transmissions occur during three transmission windows labeled 600, 602, and 604. The transmissions are shown as a solid line. The first transmission, during window 600, has a particular phase 606, which is shown as a dotted line outside of the transmission windows. FIG. 6A shows that the second transmission, during window 602, has the same relative phase as the first transmission would have if the first transmission had continued up to the second transmission window 602. Likewise, the third transmission, during window 604, has the same relative phase as the first transmission would have if the first transmission had continued up to the third transmission window 604. That is, first, second, and third transmissions are phase coherent with each other in time.

Referring to FIG. 6B, three transmissions of a signal which do not have phase coherence relative to each other are shown. In the simplified signal over time plot shown in FIG. 6B, transmissions also occur during the three transmission windows, but in the example illustrated in FIG. 6B, the second transmission, during window 602, does not have the same relative phase as the first transmission would have if the first transmission had continued up to the second transmission window 602. Likewise, the third transmission, during window 604, does not have the same relative phase as the first transmission would have if the first transmission had continued up to the third transmission window 604. That is, the first and second transmissions are not phase coherent with each other in time. In FIG. 6B, the second transmission is out of phase with the first transmission by a first phase delay 608, and the third transmission is out of phase with the first transmission by a second phase delay 610.

Many new use cases require coherent operations, i.e., they require that a signal have a fixed phase reference over several consecutive transmissions or occasions. Example use cases include doppler measurements in RF sensing, and improved angular resolution in massive input/massive output (MIMO) radar/sensing.

Referring to FIG. 6C, a MIMO antenna array 620 and its virtual equivalent 622 are shown. The MIMO antenna array 620 includes two transmit antennas, Tx0 and Tx1, and four receive antennas, Rx0, Rx1, Rx2, and Rx3. With this antenna array 620, angle of arrival (AoA) estimation can be realized with FFT over the multiple receive antennas. By appropriate antenna spacing d between Rx antennas and N*d between Tx antennas, MIMO radar with NTx and NRx is virtually equivalent to 1-Tx and NTx·NRx-Rx. Thus, the 2Tx, 4Rx MIMO antenna array 620 is equivalent to the 1Tx, 8Rx virtual MIMO antenna array 622 (i.e., the additional Rx antennas Rx4, Rx5, Rx6, and Rx7 are virtually present). The additional Rx antennas provide higher angular resolution if the Tx antennas transmit orthogonal waveforms. For frequency modulate continuous wave (FMCW) MIMO radar, typically, time division multiplexing (TDM) is assumed for FMCW, which would decrease the maximum unambiguous velocity |v|max≤λ/(4NTxT chirp) for MIMO radar. OFDM MIMO radar is also possible, e.g., using a wideband signal such as PRS, but in this case also, there must be phase coherence across the antennas.

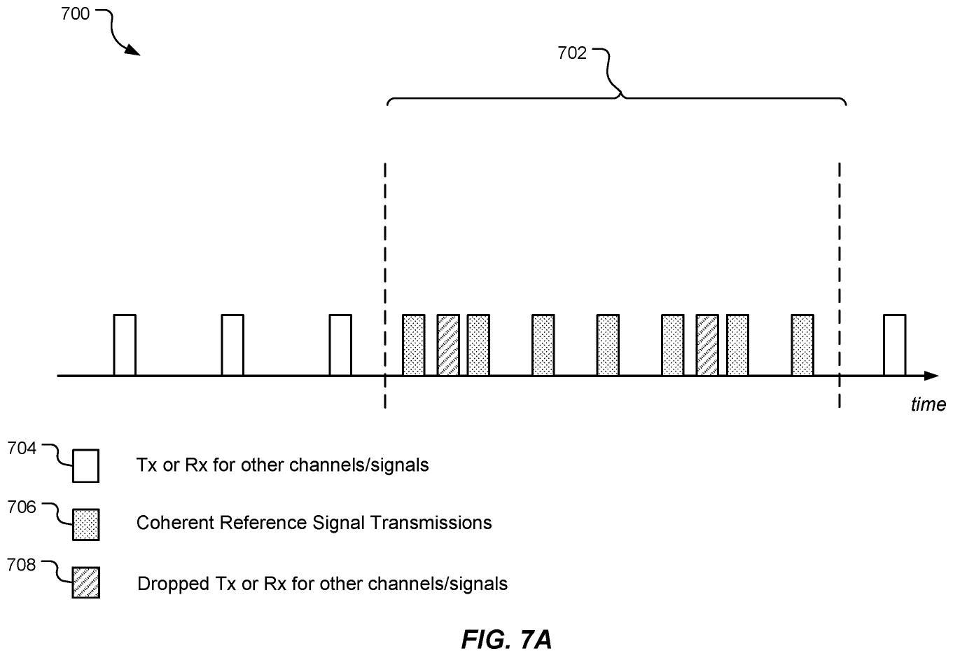

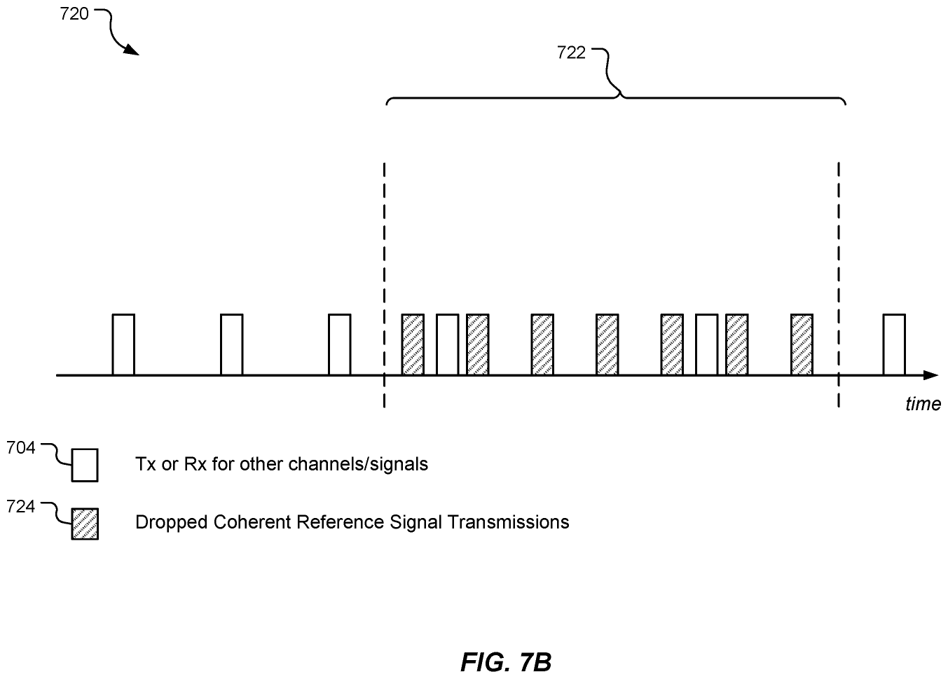

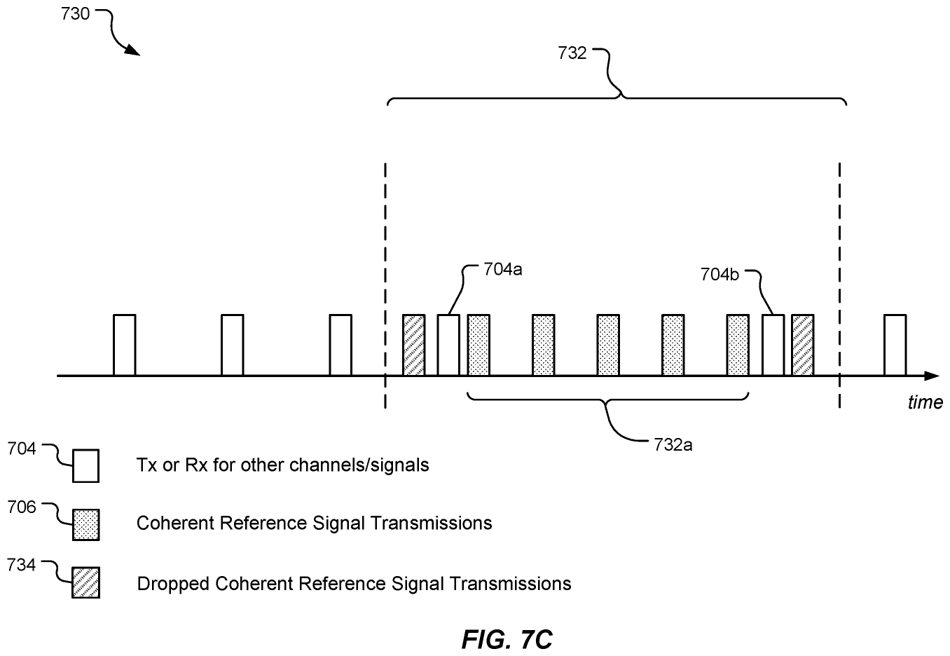

Referring to FIGS. 7A-7C, diagrams of example use cases for reference signal transmissions with gap-assisted coherent transmissions are shown. In general, the techniques provide herein address phase discontinuity issues through the configuration of transmission gaps (TGs). TGs may be utilized used by a transmitting node to enable phase-coherent transmissions. As used herein, the term gap-assisted coherent transmissions refers to phase-coherent transmissions during the TGs. In an example, a transmitting node may transmit coherent reference signals (RSs) during a TG, and not transmit other signals such as communication signals during the TG. The TGs may be configured and activated by a network resource, such as a sensing entity (or the LMF 270). TGs may be implemented on the UE side and/or on the TRP side and may enable coherent reference signal transmissions from either or both sides. One or more coherent reference signal (RS) transmissions may occur within a TG. The configurations of the RSs may be established by the UE, TRP or other network resources (e.g., network server). A TG may be configured with a length (e.g., duration of time) and a periodicity. The periodicity may be determined based on the configured RS to be transmitted during the TG. The periodicity may be indicated by reference to RS set periodicity, or independently. A TG may be aperiodic, periodic, or semi-periodic. A TG may also be pre-configured, and activated and deactivated based on wired and wireless messaging (e.g., NPP, RRC, Downlink Control Information (DCI), Medium Access Control (MAC), etc.). An activation request may be initiated from a sensing entity (or LMF 270), or from the UE. This can be a lower layer activation. A TG is distinct from other timing gaps known in the art, such as measurement gaps (MGs), because a TG is associated with a transmit side whereas the MGs are associated with the receive side. For example, in some positioning applications, a UE may be configured to receive DL PRS during a MG.

Referring to FIG. 7A, in a first use case 700, a wireless node (e.g., a base station 102/180, UE 104/182) may be configured with a first TG 702 that is not expected to process simultaneously received or transmitted signals. That is, during the TG 702, configured coherent RSs are transmitted and any overlapping or partially overlapping transmissions or receptions are dropped. For example, the wireless node may be configured to transmit and/or receive signals 704. During the configured first TG 702, the wireless node is configured to prioritize coherent reference signal transmissions 706 over the signals 704. The signals 704 within the TG 702 that are not received and/or not transmitted are depicted as dropped signals 708 in FIG. 7A.

Referring to FIG. 7B, in a second use case 720, a wireless node (e.g., a base station 102/180, UE 104/182) may be configured with a second TG 722 with priority rules to enable transmission and reception of signals 704 which have a higher priority than the coherent reference signal transmissions 724. Thus, during the second TG 722 the coherent reference signal transmissions 724 are dropped.

Referring to FIG. 7C, in a third use case 730, a wireless node (e.g., a base station 102/180, UE 104/182) may be configured with a third TG 732 with priority rules to enable the transmission and reception of signals 704 which have a higher priority than at least some of the coherent reference signal transmissions 706. For example, higher priority measurements and/or transmissions 704a-704b may be carried out by the wireless node and some of the coherent reference signals 734 will be dropped. The wireless node may be configured to transmit coherent reference signal resources that lie between the higher priority measurements/transmissions. For example, the wireless node may be configured to transmit resources for the coherent reference signal transmissions 706 between the higher priority measurements and/or transmissions 704a-704b. The wireless node may be configured to report (e.g., to a UE, gNB, sensing entity) the indices of the first and last transmitted resources from the configured resource set. The prioritization scheme may effectively reduce the duration of the third TG 732 to a portion 732a of the third TG 732. In an example, the priority rules can be a function of a reference signal Bandwidth Part (RS BWP) and the BWP for the other overlapping channels/signals. Priority rules may depend on whether the overlapping activity is a DL measurement or UL transmission. For example, UL transmissions may be dropped and DL measurements may be allowed.

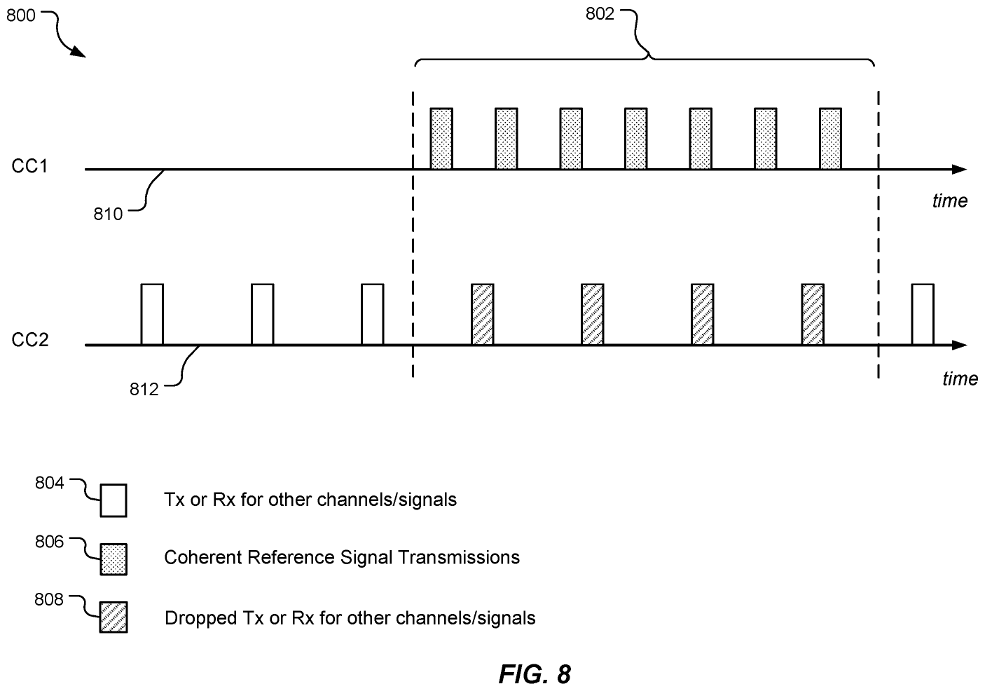

Referring to FIG. 8, a diagram 800 of example gap-assisted coherent transmissions with multiple component carriers is shown. A wireless node (e.g., a base station 102/180, UE 104/182) may be configured with multiple carriers such as a first component carrier 810 (CC1) and a second component carrier 812 (CC2) on a single TX chain. A TG 802 may be utilized on the multiple carriers. For example, coherent reference signal transmissions 806 may be scheduled on one channel during the TG 802, and other transmit and/or receive signals 804 may be dropped on another channel during the TG 802 (i.e., the dropped transmit and/or receive signals 808). In an example, the second carrier 812 may be configured with a Physical Uplink Shared Channel (PUSCH) transmission (e.g., the signals 804), and the first carrier 810 may be configured with the coherent RS transmission 806 which are overlapping in time. In this example, the PUSCH on the second carrier 812 is dropped.

A wireless node may be configured with independent chains such that one component carrier may operate independent of other component carriers. In this example, the respective component carriers may utilize the prioritization methods described in FIGS. 7A-7C. TGs may be configured based on the capabilities of a wireless node. A wireless node, such as a UE, may provide capability information to a network resource (e.g., the LMF 270, sensing entity), and the network may configure TGs based at least in part on the capability information. The TGs may be based on gaps in different frequency ranges. For example, a TG may be configured per FR-1 gaps, and/or per FR-2 gaps. In an example, multiple sets of coherent transmissions may be scheduled in a TG. For example, a wireless node may be configured to transmit SRS 4 times on a first beam (coherent), switch to a second beam, and then transmit 4 times on the second beam. The different sets may be coherent or non-coherent. If a wireless node is configured for digital beamforming, then all 8 RS in the above example may be coherent. If analog beamforming is utilized, then the signals may be coherent or non-coherent based on the respective RF chain implementations.

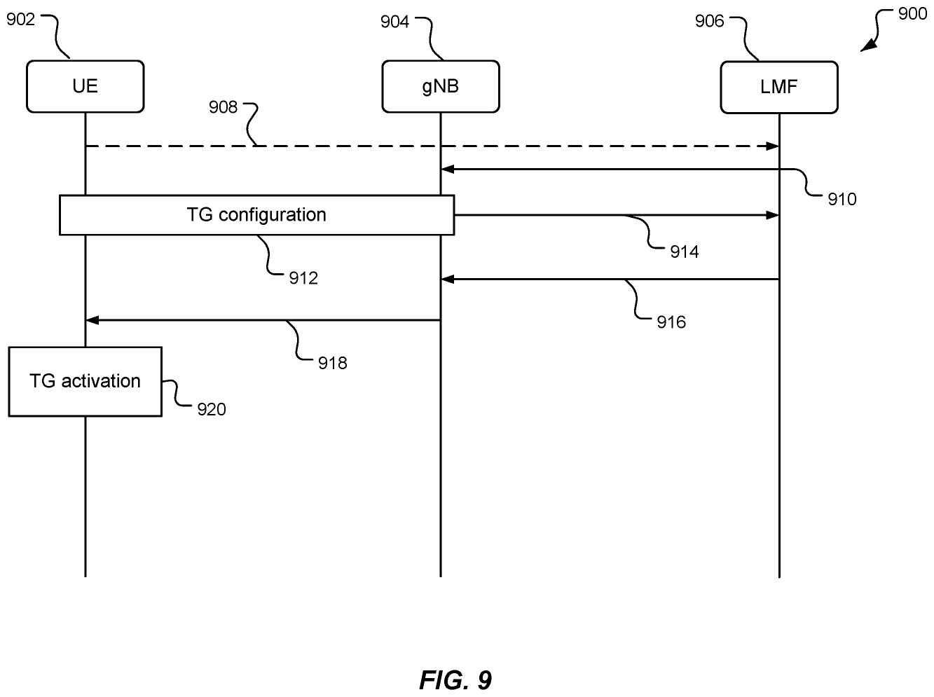

Referring to FIG. 9, an example message flow diagram 900 for providing transmission gap configuration information is shown. The message flow diagram 900 includes example nodes in the communication system such as an UE 902, a gNB 904, and a network server such as a LMF 906 or other sensing entity. The nodes and messages in the message flow diagram 900 are examples, and not limitations, as other nodes and messages may be used to disseminate and/or activate TG configuration information throughout the communications system 100. The LMF 906 may communicate with the gNB 904 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 904 and the LMF 906. The LMF 906 and the UE 902 may communicate using an LTE Positioning Protocol (LPP), which may be defined in 3GPP TS 36.355 and TS 37.355. The LMF 906 and the UE 902 may also or instead communicate using a New Radio Positioning Protocol (which may be referred to as NPP or NRPP), which may be the same as, similar to, or an extension of LPP. Here, LPP and/or NPP messages may be transferred between the UE 902 and the LMF 906 via the serving gNB (e.g., the gNB 904).

The gNB 904 may include a radio unit (RU), a distributed unit (DU), and a central unit (CU) (not shown in FIG. 9). The RU, DU, and CU may be configured to divide the functionality of a gNB. An interface between the CU and the DU is referred to as an F1 interface. The Xn interface may be used for communications between different gNBs. The RU is configured to perform digital front end (DFE) functions (e.g., analog-to-digital conversion, filtering, power amplification, transmission/reception) and digital beamforming, and includes a portion of the physical (PHY) layer. The RU may perform the DFE using massive multiple input/multiple output (MIMO) and may be integrated with one or more antennas of the gNB 904. The DU may host the Radio Link Control (RLC), Medium Access Control (MAC), and physical layers of the gNB 904. One DU can support one or more cells, and each cell is supported by a single DU. The operation of the DU may be controlled by the CU. The CU may be configured to perform functions for transferring user data, mobility control, radio access network sharing, positioning, session management, etc. although some functions are allocated exclusively to the DU. The CU may host the Radio Resource Control (RRC), Service Data Adaptation Protocol (SDAP), and Packet Data Convergence Protocol (PDCP) protocols of the gNB 904. The UE 902 may communicate with the CU via RRC, SDAP, and PDCP layers, with the DU via the RLC, MAC, and PHY layers, and with the RU via the PHY layer.

In operation, a sensing entity, such as the LMF 906, may request the gNB 904 to pre-configure TGs for the UE 902. In an example, the UE 902 may be configured to provide one or more capability messages 908 to inform the LMF 906 (or other sensing entity) of the UE's abilities to utilize gap-assisted coherent transmissions as described herein. The LMF 906 may provide RS transmission configuration information and corresponding TG configuration information to the gNB 904 via one or more RS configuration information messages 910. At stage 912, the gNB 904 may be configured to send or exchange TG configuration messages with the UE 902 to provide pre-configured TG configuration(s) based on the RS configuration information provided by the LMF 906. In an example, each pre-configured TG may be associated with an ID value. The UE 902 may be configured to provide a confirmation or rejection regarding the pre-configured TG provided by the gNB 904. Upon receipt of a confirmation from the UE 902 at stage 912, the gNB 904 may indicate the success of the pre-configuration to the sensing entity (e.g., the LMF 906) via one or more configuration confirmation messages 914. If the TG cannot be preconfigured by the gNB 904, an indication of a configuration failure may be provided via the configuration confirmation messages 914. In an example, a failure to configure a TG may result in dropping the RS transmissions.

When a TG is needed, the UE 902 or the sensing entity (e.g., LMF 906) may send a TG activation request message 916 to the gNB 904 to activate the TG at the UE 902. The activation request message 916 may include the TG ID information. The gNB 904 may communicate a TG activation message 918 via a wireless communication protocol. In an example, the activation message 918 may be provided via DCI, MAC-CE or RRC signaling. The TG activation message 918 may include the TG ID information. At stage 920, the UE 902 may configure a TG based on the TG activation message 918.

In an example, the UE 902 may be configured to indicate its support for low latency TG activation requests (e.g., DCI, MAC-CE). This may be provided as part of sensing or positioning capabilities exchange procedures, such as via the one or more capability messages 908. For example, a new LPP field (e.g., tg-ActivationRequest), may be utilized to indicate that the UE 902 supports low latency transmissions gap activation request for Coherent RS transmissions. In an example, if some RS are linked to the TG, the activation of the RS transmissions may implicitly activate the TG, or vice versa. The activation of the TG may activate the configured RS transmissions. In an example, the activation of the TG may be performed independently of the activation of RS transmissions. Lower-level de-activation messages may be used to deactivate the transmissions of RS resources.

In an example, a UE 902 configured with coherent RS transmissions and requiring a TG, may request a TG from a network server such as a sensing entity or the LMF 906. The request may be supported by RRC signaling and the requested TG may be aperiodic, periodic, semi-periodic. The request may include UE capability for coherent RS transmissions if not previously provided. The capability is the need for a TG for coherent RS transmissions. Upon completion of the coherent transmissions, the UE 902 may indicate the completion of the transmissions through RRC signaling.

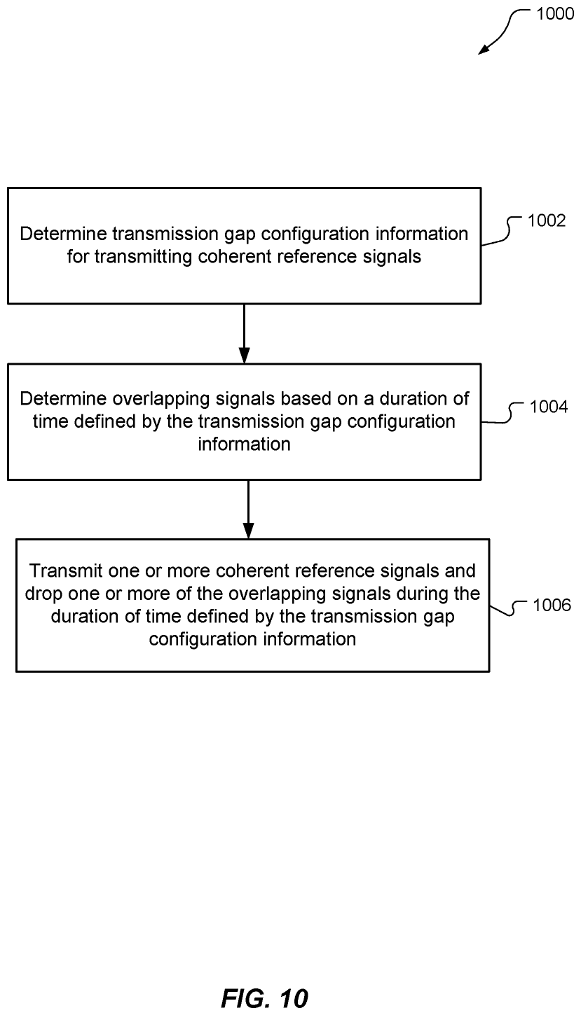

Referring to FIG. 10, with further reference to FIGS. 1-9, a method 1000 for transmitting coherent reference signals with a wireless node includes the stages shown. A UE 302 or a base station 304, such as a TRP or other wireless nodes described herein, may be configured to transmit coherent reference signals. The method 1000 is, however, an example and not limiting. The method 1000 may be altered, e.g., by having stages added, removed, rearranged, combined, performed concurrently, and/or having single stages split into multiple stages.

At stage 1002, the method includes determining transmission gap configuration information for transmitting coherent reference signals. The transceiver 310 and the processing system 332 in the UE 302, and/or the transceiver 350 and the processing system 384 in the base station 304 are means for determining transmission gap configuration information. The configurations of the RSs may be established by the UE 902, the gNB 904, or other network resources (e.g., a sensing entity such as the LMF 906). The TG configuration information may include parameters such as duration of time (e.g., length) and periodicity. The periodicity may be determined based on the configured RS to be transmitted during the TG. The periodicity may be indicated by reference to RS set periodicity, or independently. A TG may be aperiodic, periodic, or semi-periodic. A TG may be pre-configured based on the TG configuration information, and activated and deactivated based on wired and wireless messaging such as LPP, NPPa, RRC, DCI, MAC, etc. In an example, a sensing entity such as the LMF 906 may be configured to provide TG configuration information to the gNB 904 and/or the UE 902 via one or more RS configuration information messages 910. The TG configuration information may be based on the capabilities of the transmitting station, such as the UE 902 and the gNB 904. The UE 902 and the gNB 904 may determine TG configuration information based on other signaling techniques. In an example, the TG configuration information may persist in a local memory in the transmitting station and determining the TG configuration information includes accessing the local memory.

At stage 1004, the method includes determining overlapping signals based on a duration of time defined by the transmission gap configuration information. The processing system 332 in the UE 302, and/or the processing system 384 in the base station 304 are means for determining overlapping signals. The transmitting stations (e.g., the UE 902 and the gNB 904) may be configured to compare the schedule information for other reference signals (e.g., PRS, PTRS, CSI, etc.) in view of the TG configuration information to determine if any signals are scheduled for the duration of time defined by the TG configuration information. For example, PRS resources may include periodicity and offset parameters to define when DL-PRS and/or SRS are to be transmitted or received. Priority rules may be defined to determine the behavior of the transmitting station during the TG when the overlapping signals are present.

At stage 1006, the method includes transmitting one or more coherent reference signals and dropping one or more of the overlapping signals during the duration of the time defined by the transmission gap configuration information. The transceiver 310 and the processing system 332 in the UE 302, and/or the transceiver 350 and the processing system 384 in the base station 304 are means for transmitting one or more coherent RS and dropping one or more of the overlapping signals. In an example, referring to FIG. 7A, a transmitting station such as the UE 902 and the gNB 904 may be configured to transmit the configured coherent RSs 706 during the TG 702 and the overlapping or partially overlapping transmissions or receptions may be dropped (i.e., the dropped Tx or Rx for other channels/signals 708). In an example, referring to FIG. 7C, priority rules may be defined such that dropped measurements or transmissions may be determined according to the rules. The measurements and/or transmissions with higher priorities (e.g., 704a, 704b) during the TG 732 may be completed by the transmitting station, and one or more of the coherent RS resources within the TG 732 may be transmitted. The transmitting station may report the indices of the transmitted resources to a sensing entity. In an example, the priority rules may be a function of the RS BWP and the BWP for the other overlapping channels/signals determined at stage 1004. The priority rules may depend on whether the overlapping activity is a DL measurement or UL transmission. For example, UL transmissions may be dropped, whereas DL measurements may be allowed. Other priority rules may be used to determine which coherent reference signals are transmitted and which other signals are transmitted or received during a TG.

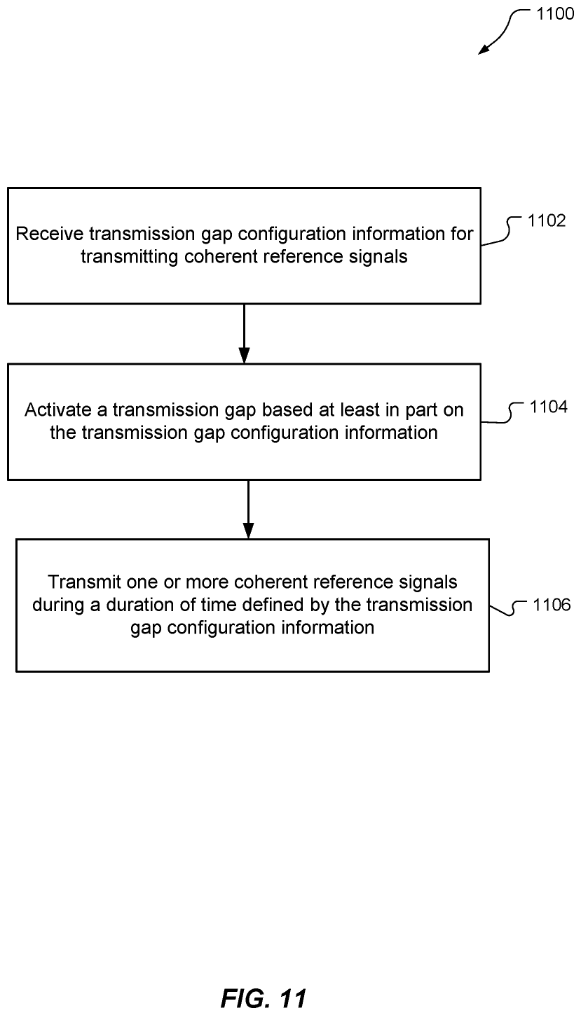

Referring to FIG. 11, with further reference to FIGS. 1-9, a method 1100 for activating a transmission gap for transmitting coherent reference signals with a wireless node includes the stages shown. A UE 302 or a base station 304, such as a TRP or other wireless nodes described herein, may be configured to transmit coherent reference signals. The method 1100 is, however, an example and not limiting. The method 1100 may be altered, e.g., by having stages added, removed, rearranged, combined, performed concurrently, and/or having single stages split into multiple stages.

At stage 1102, the method includes receiving transmission gap configuration information for transmitting coherent reference signals. The transceiver 310 and the processing system 332 in the UE 302, and/or the transceiver 350 and the processing system 384 in the base station 304 are means for receiving transmission gap configuration information. The configurations of the RSs may be established by the UE 902, the gNB 904, or other network resources (e.g., a sensing entity such as the LMF 906). The TG configuration information may include parameters such as duration of time and periodicity. The periodicity may be determined based on the configured RS to be transmitted during the TG. The periodicity may be indicated by reference to RS set periodicity, or independently. In an example, the TG may be pre-configured based on the TG configuration information received via wired or wireless messaging such as LPP, NPPa, RRC, In an example, a sensing entity such as the LMF 906 may be configured to provide TG configuration information to the gNB 904 and/or the UE 902 via one or more RS configuration information messages 910. The TG configuration information may be based on the capabilities of the transmitting station, such as the UE 902 and the gNB 904. The UE 902 and the gNB 904 may receive TG configuration information based on other signaling techniques.

At stage 1104, the method includes activating a transmission gap based at least in part on the transmission gap configuration information. The transceiver 310 and the processing system 332 in the UE 302, and/or the transceiver 350 and the processing system 384 in the base station 304 are means for activating a TG. A TG may be aperiodic, periodic, or semi-periodic. In an example, the TG may be pre-configured based on the TG configuration information received at stage 1102, and activated and deactivated based on wired and wireless messaging such as RRC, DCI, MAC, etc. In an example, when a TG is needed, the UE 902 or the sensing entity (e.g., LMF 906) may send a TG activation request message 916 to the gNB 904 to activate the TG at the transmitting station. The activation request message 916 may include the TG ID information. The gNB 904 may communicate a TG activation message 918 to the UE 902 via DCI, MAC-CE or RRC signaling. The TG activation message 918 may include the TG ID information. Other signaling techniques may be used to activate the TG. In an example, the UE 902 may be configured to indicate its support for low latency TG activation requests (e.g., DCI, MAC-CE). This may be provided as part of sensing or positioning capabilities exchange procedures, such as via the one or more capability messages 908. For example, a new LPP field (e.g., tg-ActivationRequest), may be utilized to indicate that the UE 902 supports low latency transmissions gap activation request for coherent RS transmissions. In an example, if some RS are linked to the TG, the activation of the RS transmissions may implicitly activate the TG, or vice versa. The activation of the TG may activate the configured RS transmissions. In an example, the activation of the TG may be performed independently of the activation of RS transmissions. Lower-level de-activation messages may be used to deactivate the transmissions of RS resources.

At stage 1106, the method includes transmitting one or more coherent reference signals during a duration of time defined by the transmission gap configuration information. The transceiver 310 and the processing system 332 in the UE 302, and/or the transceiver 350 and the processing system 384 in the base station 304 are means for transmitting one or more coherent RS. The one or more coherent reference signals have a fixed phase reference for several consecutive transmissions. During the transmission gap, the phase coherence continuity may be achieved under certain conditions such as reducing beam switching, reducing TDD switching, reducing changes to RF hardware configuration, or reducing changes in PA/LNA gain states. Other conditions may also be used to realize phase coherence continuity. In an example, a network entity (e.g., sensing entity, LMF 906) may provide a transmission gap deactivation message and the wireless node may be configured to deactivate the transmission gap in response to receiving the deactivation message.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

Implementation examples are described in the following numbered clauses:

Clause 1. A method for transmitting coherent reference signals with a wireless node, comprising: determining transmission gap configuration information for transmitting coherent reference signals; determining overlapping signals based on a duration of time defined by the transmission gap configuration information; and transmitting one or more coherent reference signals and dropping one or more of the overlapping signals during the duration of time defined by the transmission gap configuration information.

Clause 2. The method of clause 1 wherein the overlapping signals include one or more signals to be received by the wireless node.

Clause 3. The method of clause 1 wherein the overlapping signals include one or more signals to be transmitted by the wireless node.

Clause 4. The method of clause 1 wherein the wireless node is a transmission reception point.

Clause 5. The method of clause 1 wherein the wireless node is a user equipment.

Clause 6. The method of clause 1 wherein determining the transmission gap configuration information includes receiving the transmission gap configuration information from a network server.

Clause 7. The method of clause 1 wherein the transmission gap configuration information includes a periodicity parameter.

Clause 8. The method of clause 1 wherein dropping one or more of the overlapping signals includes dropping all of the overlapping signals occurring during the duration of time defined by the transmission gap configuration information.

Clause 9. The method of clause 1 wherein transmitting the one or more coherent reference signals includes transmitting at least one coherent reference signal between two of the overlapping signals within the duration of time defined by the transmission gap configuration information.

Clause 10. The method of clause 1 wherein the one or more coherent reference signals are transmitted on a first component carrier and the overlapping signals are on a second component carrier.

Clause 11. A method for activating a transmission gap for transmitting coherent reference signals with a wireless node, comprising: receiving transmission gap configuration information for transmitting coherent reference signals; activating the transmission gap based at least in part on the transmission gap configuration information; and transmitting one or more coherent reference signals during a duration of time defined by the transmission gap configuration information.

Clause 12. The method of clause 11 wherein the wireless node is a transmission reception point.

Clause 13. The method of clause 11 wherein the wireless node is a user equipment.

Clause 14. The method of clause 11 wherein the transmission gap configuration information is received from a network server.

Clause 15. The method of clause 14 further comprising providing transmission gap capabilities information to the network server, and wherein the transmission gap configuration information is based at least in part on the transmission gap capabilities information.

Clause 16. The method of clause 11 wherein activating the transmission gap includes receiving an activation message via a wireless communication protocol.

Clause 17. The method of clause 16 wherein the activation message is provided via one of a radio resource control (RRC) signal, a downlink communication information (DCI) signal, or a medium access control (MAC) control element (CE).

Clause 18. The method of clause 11 further comprising providing a transmission gap configuration request to a network server, wherein the transmission gap configuration information is based at least in part on the transmission gap configuration request.

Clause 19. The method of clause 11 wherein activating the transmission gap includes at least one of an aperiodic, a periodic, and a semi-periodic activation configuration.

Clause 20. The method of clause 11 further comprising deactivating the transmission gap in response to receiving a transmission gap deactivation message from a network entity.

Clause 21. An apparatus, comprising: a memory; at least one transceiver; at least one processor communicatively coupled to the memory and the at least one transceiver, and configured to: determine transmission gap configuration information for transmitting coherent reference signals; determine overlapping signals based on a duration of time defined by the transmission gap configuration information; and transmit one or more coherent reference signals and dropping one or more of the overlapping signals during the duration of time defined by the transmission gap configuration information.

Clause 22. The apparatus of clause 21 wherein the overlapping signals include one or more signals to be received.

Clause 23. The apparatus of clause 21 wherein the overlapping signals include one or more signals to be transmitted.

Clause 24. The apparatus of clause 21 wherein the at least one processor is further configured to receive the transmission gap configuration information from a network server.

Clause 25. The apparatus of clause 21 wherein the transmission gap configuration information includes a periodicity parameter.

Clause 26. The apparatus of clause 21 wherein the at least one processor is further configured to drop all of the overlapping signals occurring during the duration of time defined by the transmission gap configuration information.

Clause 27. The apparatus of clause 21 wherein the at least one processor is further configured to transmit at least one coherent reference signal between two of the overlapping signals within the duration of time defined by the transmission gap configuration information.

Clause 28. The apparatus of clause 21 wherein the one or more coherent reference signals are transmitted on a first component carrier and the overlapping signals are on a second component carrier.

Clause 29. An apparatus, comprising: a memory; at least one transceiver; at least one processor communicatively coupled to the memory and the at least one transceiver, and configured to: receive transmission gap configuration information for transmitting coherent reference signals; activate a transmission gap based at least in part on the transmission gap configuration information; and transmit one or more coherent reference signals during a duration of time defined by the transmission gap configuration information.

Clause 30. The apparatus of clause 29 wherein the at least one processor is further configured to receive the transmission gap configuration information from a network server.

Clause 31. The apparatus of clause 30 wherein the at least one processor is further configured to provide transmission gap capabilities information to the network server, and the transmission gap configuration information is based at least in part on the transmission gap capabilities information.

Clause 32. The apparatus of clause 29 wherein the at least one processor is further configured to receive an activation message via a wireless communication protocol to activate the transmission gap.

Clause 33. The apparatus of clause 32 wherein the at least one processor is further configured to receive the activation message via one of a radio resource control (RRC) signal, a downlink communication information (DCI) signal, or a medium access control (MAC) control element (CE).

Clause 34. The apparatus of clause 29 wherein the at least one processor is further configured to provide a transmission gap configuration request to a network server, and the transmission gap configuration information is based at least in part on the transmission gap configuration request.

Clause 35. The apparatus of clause 29 wherein the at least one processor is further configured to activate the transmission gap with at least one of an aperiodic, a periodic, and a semi-periodic activation configuration.

Clause 36. The apparatus of clause 29 wherein the at least one processor is further configured to deactivate the transmission gap in response to receiving a transmission gap deactivation message from a network entity.

Clause 37. An apparatus for transmitting coherent reference signals with a wireless node, comprising: means for determining transmission gap configuration information for transmitting coherent reference signals; means for determining overlapping signals based on a duration of time defined by the transmission gap configuration information; and means for transmitting one or more coherent reference signals and dropping one or more of the overlapping signals during the duration of time defined by the transmission gap configuration information.

Clause 38. An apparatus for activating a transmission gap for transmitting coherent reference signals with a wireless node, comprising: means for receiving transmission gap configuration information for transmitting coherent reference signals; means for activating the transmission gap based at least in part on the transmission gap configuration information; and means for transmitting one or more coherent reference signals during a duration of time defined by the transmission gap configuration information.

Clause 39. A non-transitory processor-readable storage medium comprising processor-readable instructions configured to cause one or more processors to transmit coherent reference signals with a wireless node, comprising code for: determining transmission gap configuration information for transmitting coherent reference signals; determining overlapping signals based on a duration of time defined by the transmission gap configuration information; and transmitting one or more coherent reference signals and dropping one or more of the overlapping signals during the duration of time defined by the transmission gap configuration information.

Clause 40. A non-transitory processor-readable storage medium comprising processor-readable instructions configured to cause one or more processors to activate a transmission gap for transmitting coherent reference signals with a wireless node, comprising code for: receiving transmission gap configuration information for transmitting coherent reference signals; activating the transmission gap based at least in part on the transmission gap configuration information; and transmitting one or more coherent reference signals during a duration of time defined by the transmission gap configuration information.

What is claimed is:

1. A method for transmitting coherent reference signals with a wireless node, comprising:
determining transmission gap configuration information for transmitting coherent reference signals;
determining overlapping signals based on a duration of time defined by the transmission gap configuration information; and
transmitting one or more coherent reference signals and dropping one or more of the overlapping signals during the duration of time defined by the transmission gap configuration information.

2. The method of claim 1 wherein the overlapping signals include one or more signals to be received by the wireless node.

3. The method of claim 1 wherein the overlapping signals include one or more signals to be transmitted by the wireless node.

4. The method of claim 1 wherein the wireless node is a transmission reception point.

5. The method of claim 1 wherein the wireless node is a user equipment.

6. The method of claim 1 wherein determining the transmission gap configuration information includes receiving the transmission gap configuration information from a network server.

7. The method of claim 1 wherein the transmission gap configuration information includes a periodicity parameter.

8. The method of claim 1 wherein dropping one or more of the overlapping signals includes dropping all of the overlapping signals occurring during the duration of time defined by the transmission gap configuration information.

9. The method of claim 1 wherein transmitting the one or more coherent reference signals includes transmitting at least one coherent reference signal between two of the overlapping signals within the duration of time defined by the transmission gap configuration information.

10. The method of claim 1 wherein the one or more coherent reference signals are transmitted on a first component carrier and the overlapping signals are on a second component carrier.

11. A method for activating a transmission gap for transmitting coherent reference signals with a wireless node, comprising:
receiving transmission gap configuration information for transmitting the coherent reference signals;
activating the transmission gap based at least in part on the transmission gap configuration information; and
transmitting one or more coherent reference signals during a duration of time defined by the transmission gap configuration information.

12. The method of claim 11 wherein the wireless node is a transmission reception point.

13. The method of claim 11 wherein the wireless node is a user equipment.

14. The method of claim 11 wherein the transmission gap configuration information is received from a network server.

15. The method of claim 14 further comprising providing transmission gap capabilities information to the network server, and wherein the transmission gap configuration information is based at least in part on the transmission gap capabilities information.

16. The method of claim 11 wherein activating the transmission gap includes receiving an activation message via a wireless communication protocol.

17. The method of claim 16 wherein the activation message is provided via one of a radio resource control (RRC) signal, a downlink communication information (DCI) signal, or a medium access control (MAC) control element (CE).

18. The method of claim 11 further comprising providing a transmission gap configuration request to a network server, wherein the transmission gap configuration information is based at least in part on the transmission gap configuration request.

19. The method of claim 11 wherein activating the transmission gap includes at least one of an aperiodic, a periodic, and a semi-periodic activation configuration.

20. The method of claim 11 further comprising deactivating the transmission gap in response to receiving a transmission gap deactivation message from a network entity.

21. An apparatus, comprising:
a memory;
at least one transceiver;
at least one processor communicatively coupled to the memory and the at least one transceiver, and configured to:
determine transmission gap configuration information for transmitting coherent reference signals;
determine overlapping signals based on a duration of time defined by the transmission gap configuration information; and
transmit one or more coherent reference signals and dropping one or more of the overlapping signals during the duration of time defined by the transmission gap configuration information.

22. The apparatus of claim 21 wherein the overlapping signals include one or more signals to be received or signals to be transmitted.

23. The apparatus of claim 21 wherein the at least one processor is further configured to receive the transmission gap configuration information from a network server.

24. The apparatus of claim 21 wherein the at least one processor is further configured to drop all of the overlapping signals occurring during the duration of time defined by the transmission gap configuration information.

25. The apparatus of claim 21 wherein the at least one processor is further configured to transmit at least one coherent reference signal between two of the overlapping signals within the duration of time defined by the transmission gap configuration information.

26. An apparatus, comprising:
a memory;
at least one transceiver;
at least one processor communicatively coupled to the memory and the at least one transceiver, and configured to:
receive transmission gap configuration information for transmitting coherent reference signals;
activate a transmission gap based at least in part on the transmission gap configuration information; and
transmit one or more coherent reference signals during a duration of time defined by the transmission gap configuration information.

27. The apparatus of claim 26 wherein the at least one processor is further configured to receive an activation message via a wireless communication protocol to activate the transmission gap.

28. The apparatus of claim 26 wherein the at least one processor is further configured to provide a transmission gap configuration request to a network server, and the transmission gap configuration information is based at least in part on the transmission gap configuration request.

29. The apparatus of claim 26 wherein the at least one processor is further configured to activate the transmission gap with at least one of an aperiodic, a periodic, and a semi-periodic activation configuration.

30. The apparatus of claim 26 wherein the at least one processor is further configured to deactivate the transmission gap in response to receiving a transmission gap deactivation message from a network entity.
